(19) United States
(12) Patent Application Publication
(10) Pub. No.: US 2010/0228480 A1
(43) Pub. Date: Sep. 9, 2010

(54) SPACE SATELLITE TRACKING AND IDENTIFICATION

(76) Inventors: Paul A. LITHGOW, Queen Creek, AZ (US); Stanley O. Kennedy, JR., Littleton, CO (US); Craig A. Gravelle, Littleton, CO (US)

Correspondence Address: ROBERT M. MCDERMOTT, ESQ., 1824 FEDERAL FARM ROAD, MONTROSS, VA, 22520, US

(21) Appl. No.: 12/644,610

(22) Filed: Dec. 22, 2009

Related U.S. Application Data
(60) Provisional application No. 61/158,350, filed on Mar. 7, 2009.

(51) Int. Cl. G01C 21/00

(52) U.S. Cl. 701/226

(57) ABSTRACT

A Space Tracking and Identification (STI) method and system uses low-cost identification and location beacon devices situated on each satellite. Preferably, these beacon devices are substantially independent of the mission-specific and satellite-specific navigation and communication systems, thereby allowing their use on any satellite or other space object. The beacon preferably includes a GPS receiver, an on-board processor, and a transmitter that transmits an identifier of the satellite and location information, and optionally other navigation-related information, to a relay satellite or directly to a ground-based system. The ground system delivers the received information, or a processed version thereof, to a recipient associated with the satellite identifier. The beacon preferably uses a Sensor Enabled Notification System (SENS) transmitter that uses Code Phase Division Multiple Access (CPDMA™) to assure low-cost, low-bandwidth, and virtually unlimited extensibility.

This application claims the benefit of U.S. Provisional Patent Application 61/158,350, filed 7 Mar. 2009.

### BACKGROUND AND SUMMARY OF THE INVENTION

This invention relates to the field of satellite tracking, and in particular to a method and system that provides for satellite tracking that does not require the complex infrastructure that is conventionally used to track satellites.

The number of satellites orbiting the earth continues to increase, as does the infrastructure required to track these satellites. Current methods of tracking and identification require users to monitor space traffic from the ground and develop track performance and conjunction analysis results. These systems are manpower intensive and require significant infrastructure.

In the late 1950s, the U.S. government changed their satellite-active tracking system, to an earth-station-active system, because the satellite-active techniques required active participation on the part of the satellites, including transmissions at particular frequencies, and the first Sputnik did not follow the international agreement on satellite transmitting frequencies. Since then, satellite-passive systems have been commonly used to track satellites, and other objects in orbit, including the accumulated ‘space junk’ created over the years.

An example satellite tracking system is the U.S. Space Surveillance Network (SSN), a globally distributed network of interferometer, radar and optical tracking systems that currently tracks over 8,000 orbiting objects, using hundreds of land-based sites to perform this active tracking. The SSN uses a combination of active-tracking techniques, including phased-array radars, conventional radars, and the Ground-Based Electro-Optical Deep Space Surveillance System (GEODSS).

Because of the infrastructure costs and other limitations, the SSN does not continuously monitor the position of each orbiting object. Rather, SSN determines the orbital parameters associated with each object based on observation samples, then uses predictive techniques based on Kepler's equations of orbital motion, and other algorithms, to determine where each object is located at any particular time. These Keplerian elements are updated based on subsequent observation samples, up to 80,000 satellite observations each day. The data is transmitted directly to USSPACECOM's Space Control Center (SCC) via multiple communication means, including satellite, ground wire, microwave and phone to ensure reliable and continuous communications.

The Air Force Satellite Control Network (AFSCN) is used to control select spacecraft, generally those operated by or for the U.S. government, and others of high importance to the U.S. This network uses sub-carrier transmitter signals, in addition to the orbital parameters, to provide range information and thus a more accurate location prediction. This system also requires a substantial infrastructure and significant manpower resources.

Although the SSN database of orbital parameters is available to the providers of satellite services, the fact that any particular satellite is only one of the thousands of objects that the SSN is monitoring limits the options available to the service provider regarding real-time tracking and reporting. The fact that in early 2009, an Iridium satellite collided with a Cosmos satellite at over 20,000 miles per hour, resulting in a loss of tens of millions of dollars, amply demonstrates the limitations of current satellite tracking systems.

Although satellite service providers may provide their own infrastructures to provide more timely and accurate satellite location determinations, the costs of such an infrastructure, in terms of capital investment and operational costs are extremely high.

It would be advantageous to enable a satellite service provider to obtain real-time tracking information. It would be also be advantageous to provide this real-time tracking information using an existing communication infrastructure. It would also be advantageous to enable the satellite service provider to customize the parameters associated with the real-time reporting, including the rate of real-time updates, and other parameters. It would also be advantageous to enable the receipt of real-time tracking information from among the hundreds of currently active satellites, and potential thousands of future satellites, without requiring a significant bandwidth requirement.

These advantages, and others, can be realized by a Space Tracking and Identification (STI) method and system that uses low-cost identification and location beacons situated on each satellite. Preferably, these beacons are substantially independent of the mission-specific and satellite-specific navigation and communication systems, thereby allowing their use on any satellite. The beacon preferably includes a GPS receiver, an on-board processor, and a transmitter that transmits an identifier of the satellite and location information, and optionally other navigation-related information, to a relay satellite or directly to a ground-based system. The ground system delivers the received information, or a processed version thereof, to a recipient associated with the satellite identifier. The beacon preferably uses a Sensor Enabled Notification System (SENS) transmitter that uses Code Phase Division Multiple Access (CPDMA™) to assure low-cost, low-bandwidth, and virtually unlimited extensibility.

### BRIEF DESCRIPTION OF THE DRAWINGS

The invention is explained in further detail, and by way of example, with reference to the accompanying drawings wherein:

FIG. 1 illustrates an example block diagram of a system in accordance with this invention.

FIG. 2 illustrates an example block diagram of a processing center in accordance with this invention.

FIG. 3 illustrates an example flow diagram of a method in accordance with this invention.

FIG. 4 illustrates an example block diagram of a communication system for an embodiment of this invention.

Throughout the drawings, the same reference numerals indicate similar or corresponding features or functions. The drawings are included for illustrative purposes and are not intended to limit the scope of the invention.

### DETAILED DESCRIPTION

In the following description, for purposes of explanation rather than limitation, specific details are set forth such as the particular architecture, interfaces, techniques, etc., in order to provide a thorough understanding of the concepts of the invention. However, it will be apparent to those skilled in the art that the present invention may be practiced in other embodiments, which depart from these specific details. In like manner, the text of this description is directed to the example embodiments as illustrated in the Figures, and is not intended to limit the claimed invention beyond the limits expressly included in the claims. For purposes of simplicity and clarity, detailed descriptions of well-known devices, circuits, and methods are omitted so as not to obscure the description of the present invention with unnecessary detail.

The invention is presented using the paradigm of low-earth-orbit (LEO) satellites, although one of skill in the art will recognize that the principles of this invention are applicable to determining the location of any space vehicle, independent of whether the vehicle is traveling in any particular orbit.

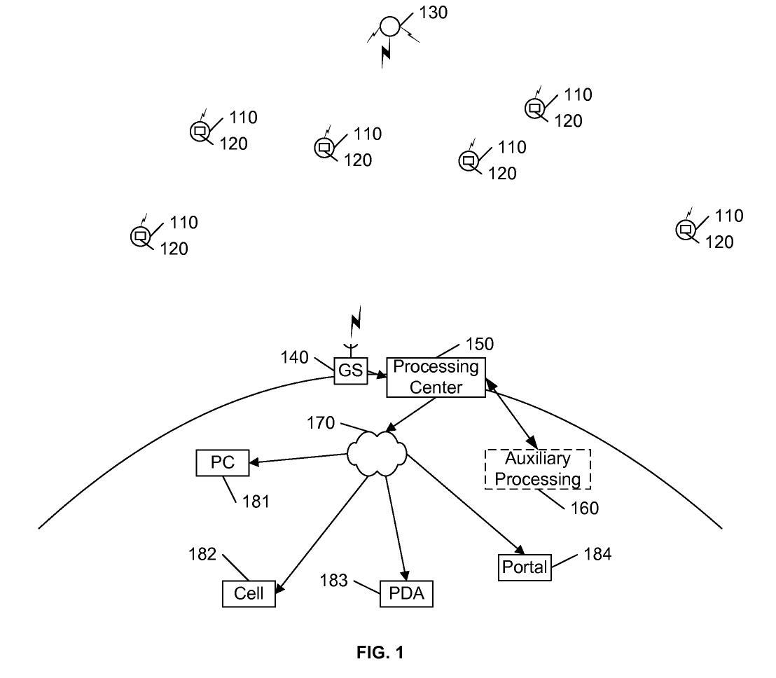

FIG. 1 illustrates an example block diagram of a system in accordance with this invention. In this example embodiment, satellites 110 include a beacon device 120 that is configured to communicate location information, from which the satellite's location can be determined. The beacon device 120 is preferably configured to operate autonomously, and may be separate from, or integrated with, other electronic devices on the satellite. The beacon device 120 may be installed in the satellite before launch, or attached to an existing satellite via on-orbit rendezvous, docking, and mating techniques, including, for example, mechanical, magnetic, and adhesive techniques.

The beacon device 120 communicates the location information to a ground station 140, optionally through one or more relay satellites 130. The transmission of the location information preferably includes an identification of the particular beacon device, allowing the identification of the satellite to which it is assigned, as well as the information required to determine the location of the satellite. If the identification of the beacon device 120 or the satellite 110 is included in the transmitted location information, the identification of the satellite may be deduced from the reported location of the satellite at the particular time of the communication from the device 120, based on the known orbital parameters associated with the satellite 110.

The ground station 140 provides a preliminary filtering of all of the messages received, and forwards the appropriate messages to the processing center 150. A processor at the processing center 150 determines the identification and location of the satellite 110 based on the location information provided by the beacon device 120, and, based on its internal database, determines the intended recipients 181-184 of this information.

In a preferred embodiment of this invention, the users/customers of the services of the processing center 150 register with the provider of the processing center 150, and inform the provider of the identification of the satellite of interest, and the identification of one or more recipients that are to be informed of the location of this satellite. The user may also specify conditional rules for sending the information to one or more of the recipients. For example, the communication of the location information may be on an ‘exception’ basis, so that, for example, the information is only sent to the identified recipients in the event that the reported location differs by a specified amount from the predicted location of the satellite. Also optionally, the processing center 150 may access other processing systems 160 to provide additional information, such as a more precise determination of the position of the satellite 110 based on Doppler and other effects, as well as a determination of the presence of other orbital objects in the vicinity of the satellite 110, based either on a reported location of the object based on this invention, or an estimated location of the object based on available orbital parameters.

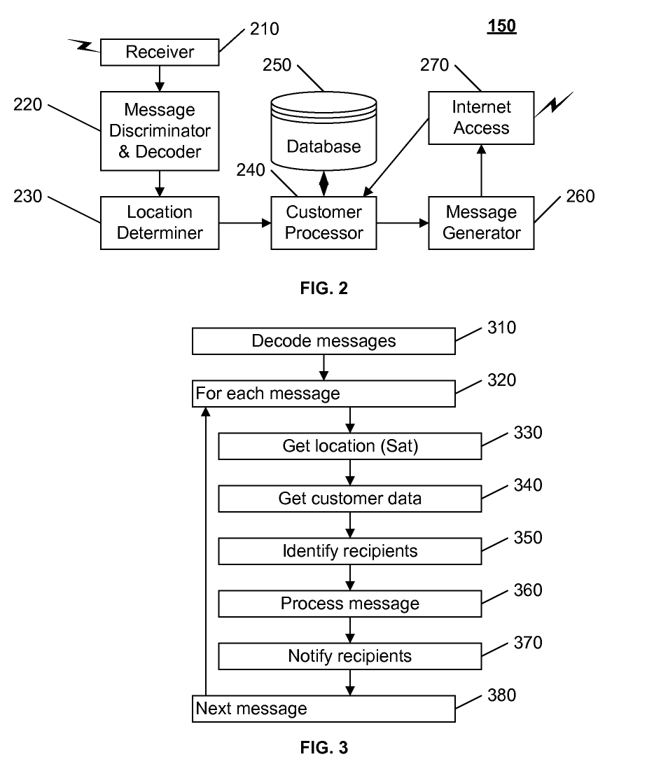

FIG. 2 illustrates an example block diagram of a processing center 150. The processing center includes a receiver 210 for receiving the messages from the beacon devices on the satellites (110-120 of FIG. 1), typically via a ground station (140). A message discriminator and decoder 220 provides each message to a location determinator 230, and the identification and location of the satellite is provided to a processor 240 that processes this information based on the user/customer's specified requirements, stored in database 250. If a customer message is to be sent, a message generator 260 creates one or more messages, based on information provided by the processor 240, and sends the messages to the intended recipients, preferably via an Internet access device 270. The Internet access device 270 is also preferably used to communicate the aforementioned customer requirements to the processor 240, for storage in the database 250.

The operation of the processing center 150 is presented in more detail in the flow diagram of FIG. 3, with reference to elements of FIGS. 1 and 2.

At 310, the messages from the satellites are decoded. The particular decoding process will be dependent upon the process used by the beacon device 120. As detailed further below, in a preferred embodiment of this invention, a Code Phase Division Multiple Access (CPDMA) technique is preferably used. U.S. Pat. No. 6,128,469, “SATELLITE COMMUNICATION SYSTEM WITH A SWEEPING HIGH-GAIN ANTENNA”, issued 3 Oct. 2000 to Ray Zenick, John Hanson, Scott McDermott, and Richard Fleeter; U.S. Pat. No. 6,396,819, “LOW-COST SATELLITE COMMUNICATION SYSTEM”, issued 28 May 2002 to Richard Fleeter, John Hanson, Scott McDermott, and Ray Zenick; U.S. Pat. No. 6,317,029, “IN-SITU REMOTE SENSING” issued 13 Nov. 2001 to Richard Fleeter; U.S. Pat. No. 7,227,884, “SPREAD-SPECTRUM RECEIVER WITH PROGRESSIVE FOURIER TRANSFORM” issued 5 Jun. 2007 to Scott A. McDermott; and U.S. Pat. No. 7,433,391, “SPREAD-SPECTRUM RECEIVER WITH FAST M-SEQUENCE TRANSFORM, issued 7 Oct. 2008 to James F. Stafford and Scott A. McDermott, disclose systems and methods that facilitate the reception and processing of messages from a large number of preferably low-cost transmitters using CPDMA, and each is incorporated by reference herein.

The loop 320-380 is repeated for each of the received and decoded messages. At 330, the satellite identification and location are determined. The determination process is based on the information in the received message provided by the beacon device 120. In a preferred embodiment, the message includes a unique identification of the satellite, and a location determined via the Global Positioning System (GPS). Depending upon the configuration of the beacon device 120, a determined latitude, longitude, and elevation may be included in the message, or the raw GPS timing information provided by the GPS satellites is included in the message, leaving the determination of the latitude, longitude, and elevation to be performed at the processing center 150.

Optionally, the beacon device 120 may be configured to transmit a sequence of location information, from which the processing center 150 can determine the velocity, and optionally the acceleration, of the satellite, as well as the reported location. Also optionally, the processing center 150 may access one or more auxiliary processing systems 160 to further enhance the accuracy of the determined location of the satellite, taking into account, for example, errors introduced by the velocity of the satellite and other factors. Optionally, GPS-Doppler compensation can be performed by the beacon device 120 to facilitate accurate location determination.

Having identified the satellite associated with the message, the customer data is accessed, at 340, to determine the appropriate actions to take, if any. In a straightforward embodiment of this invention, the customer data includes a list of e-mail addresses to forward the location of the satellite, and the location is sent as an e-mail message. In an optional embodiment, the list includes other types of Internet addresses and a corresponding protocol and/or format for composing the location message. For example, with regard to FIG. 1, in addition to sending an e-mail message to a PC 181, the location information can be formatted for compatibility with a cell phone 182, a personal data assistant (PDA) 183, or a portal 184 to another processing system or subnetwork, such as existing satellite tracking networks.

Optionally, the location information can be provided as standard Earth-centered orbital Keplerian Two Line Elements (TLEs) or Vector Covariance Message (VCM) in a format that is compatible with the U.S. Space Surveillance Network (USSSN and AFSSN) and the Air Force Satellite Control Network (AFSCN), to further augment these systems.

As noted above, in a preferred embodiment of this invention, the user/customer is provided the option of setting parameters for determining when to notify some or all of the recipients of the satellite's location. These parameters may include, for example, notifying select recipients at less frequent intervals than others, notifying some or all of the recipients only when the reported location differs by a given threshold from a predicted location of the satellite, notifying some or all of the recipients if the reported location and velocity indicates a potential collision with another space object, and so on.

The intended recipients and their requirements are determined at 350, and the appropriate messages are prepared, at 360. As noted above, these messages may be provided in any number of forms, based on the particular customer requirements.

At 370, the messages are communicated to the recipients. As noted above, in a preferred embodiment, the Internet is used to provide this communication, although one of skill in the art will recognize that any means of communication may be used.

Each received message is processed similarly, via the loop 320-380, and the next group of messages is received and processed, at 310. One of skill in the art will recognize that the sequential process of FIG. 3 may be embodied using alternative processes, such as parallel processing, event-triggered processing, and so on, and the particular sequence of steps may differ from that illustrated in FIG. 3.

As will be evident to one of skill in the art, the communication of this location information from potentially thousands of satellites can consume a significant amount of bandwidth and other resources. In particular, a conventional system that requires synchronization among the receivers and transmitters would introduce a significant amount of overhead to coordinate the communications from these hundreds or thousands of transmitters. As noted above, in a preferred embodiment of this invention, the beacon devices 120 are configured to use a Code Phase Division Multiple Access (CPDMA) technique.

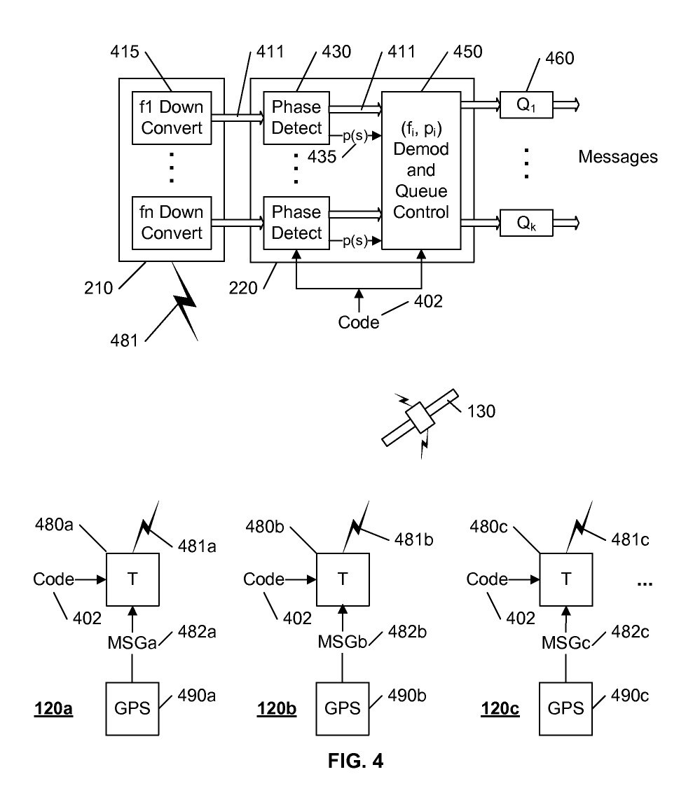

FIG. 4 illustrates an example block diagram of a communications system that is well suited for use in this invention, with reference to the elements of FIGS. 1 and 2. Illustrated are a set of beacon devices 120a-120c that are situated on satellites 110, and the receiver 210 and message discriminator and decoder 220 of the processing system 150.

The beacon devices 120a-c each includes a transmitter 480a-c and a location detecting device 490a-c, such as a GPS receiver. The transmitters 480a-c each provide a transmit signal 481a-c comprising a message 482a-c that includes the location information from the locator device 490a-c and is encoded using a spreading-code 402. The message 482a-c also preferably includes a unique identifier of the satellite 110. A “maximal length sequence” or “M-Sequence” is preferably used as the spreading code. Maximal length sequences are simple to generate using maximal linear feedback shift registers.

Each transmitter 480a-c is substantially autonomous, and each transmitter 480a-c uses the same encoding and communications parameters, including the same spreading-code 402, and the same nominal carrier frequency to provide the transmit signal 481a-c over the same communications channel. By using the same spreading code and carrier frequency, the beacon devices 120a-c can be produced at a substantial cost savings, compared to conventional CDMA devices that use a plurality of selectable codes. These transmit signals 481a-c form a composite signal 481 within this common communications channel at the nominal carrier frequency.

If two or more transmitters 480a-c transmit at the same time and at the same code-phase and essentially the same frequency, a collision results and these transmissions will not be distinguishable within the composite signal 481. If only one transmitter 480a-c is transmitting at a given code-phase with respect to the receiver, the transmitted message 482a-c will be decodable at this code-phase, even though it is at the same carrier frequency of other signals. A typical code 402 includes a sequence of hundreds or thousands of bits, thereby forming hundreds or thousands of code-phases for each message. The likelihood of two transmitters 480a-c transmitting at exactly the same code-phase at the same time with respect to the receiver 210 is slight, particularly if the message duration is relatively short.

Additionally, even if more than one transmitter 480a-c is transmitting simultaneously at the same code-phase with respect to the receiver, component variations and other factors may cause each signal to be transmitted at slightly different carrier frequencies, and will be decodable if the receiver is able to distinguish these different carrier frequencies. Accordingly, even if the hundreds or thousands of transmitters 480a-c are transmitting concurrently, the likelihood of a collision of relatively short messages will be very slight. Further, even if a collision occurs, the likelihood of repeated collisions will be extremely slight.

In the case of reporting satellite position information, each particular message is relatively insignificant, because the likelihood of the satellite veering from its predictable course is very low. That is, for example, if the beacon device 120 is configured to send a location report every minute, the absence of one or two reports between received reports will have relatively little impact on the use of these reports.

Further, the likelihood of the message being received can be increased by repeating the transmission of the message, or sending a plurality of location messages during each reporting period. The sending of a plurality of location messages will also facilitate determination of the satellites current velocity and/or acceleration.

Because the messages 281a-c are discernible based on code-phase and frequency, and do not require synchronization among the transmitters and receivers, the overhead associated with the transmissions from potentially hundreds or thousands of transmitters is substantially less than the overhead incurred in conventional wireless transmission systems, such as the conventional IEEE 802.11 communication standard.

In this example embodiment, a satellite 130 receives the composite signal 281a-c from all of the transmitters within view of the satellite 130 and relays the composite information to a ground station 140, in either a ‘store-and-forward’ mode, when the remote stations 480a-c and the ground station 140 are not contemporaneously in view of the satellite 130, or in a ‘bent-pipe’ mode, wherein the satellite 130 receives the information from the remote stations 480a-c and merely retransmits the information to the ground station 140, typically at a different transmission frequency. Because the satellite 130 and ground station 140 can be configured with directional antennas, a significant gain in signal to noise ratio can be achieved by such a configuration, without requiring a directional antenna at each beacon device 120a-c.

For the purposes of this invention, the signal 481 that is received at the ground station 140 and forwarded to the processing center 150 is considered to be the composite of the individual transmissions 481a-c, regardless of whether this composite 481 is relayed through one or more relays, such as a satellite 130, and regardless of whether it is received by a single receiver or multiple receivers.

As noted above, messages from transmitters 480a-c that may transmit at the same code-phase with respect to the receiver 210 can be distinguished within the composite signal 481 if their carrier frequencies differ by a distinguishable amount. The receiver 210 receives the composite signal 481 and down-converts the composite signal 481 to a plurality of baseband signals 411, each down-conversion frequency being within a given range of the nominal carrier frequency, the range being dependent upon the expected variance of frequencies among the transmitters 480a-c. The preferred number of down-converters is based on the given range and the selectivity/bandwidth of each down-converter, to assure that the entire range is adequately covered. One of ordinary skill in the art will recognize that alternative schemes can be used to down-convert signals from transmitters that are transmitting within the given range of a nominal frequency; for example, a single down-converter can be used if there is sufficient time to down-convert each required frequency in a sequential manner.

The receiver 210 provides the baseband signals 411 to the message discriminator and decoder 220. Within the message discriminator 220, a phase detector 430 corresponding to each baseband signal (i.e. each transmit frequency) determines the code-phase(s) 435 that contain(s) substantial signal energy. Each phase detector 430 provides this (these) code-phase(s) 435 to a demodulator 450, along with the input baseband signal 411. The demodulator 450 thereby receives each (frequency, code-phase) pair that indicates the presence of a message from one of the remote transmitters 480a-c. The demodulator 450 receives the baseband signal 411 that is provided by a particular down-converter 415, and the phase(s) 435 at which substantial energy was detected within this particular baseband signal 411.

The demodulator 450 decodes each baseband signal 411 at each of these code-phase(s) 435 to produce a decoded signal corresponding to each of these (frequency, code-phase) pairs. Given that substantial energy has been detected in this frequency-based signal 411 at each identified code-phase 435, each decoded signal is assumed to correspond to a segment of a particular transmitted message 482a-c. The demodulator 450 routes each decoded signal from each (frequency, code-phase) pair into a corresponding queue 460, thereby forming strings of messages in each queue 460, corresponding to each transmitted message 482a-c.

Although the discriminator 220 is illustrated as containing multiple phase detectors 430, to allow the detectors 430 to process the output of each down-converter 415 in parallel, one of ordinary skill in the art will recognize that a single phase detector can be used, if there is sufficient time to sequentially detect each phase within each down-converted signal 411. Preferably, the efficiency of the discriminator 220 is such that it allows the detection process to be accomplished via software running on a general purpose processor, or on a signal processor, as well as via conventional hardware devices.

In an example embodiment, messages 281a-c that contain location, velocity, and time are transmitted as bursts of 100 bps binary phase shift keying (BPSK) modulated data that is spread across 2.5 MHz of bandwidth at approximately one second per transmission. The size of the message is dependent upon the desired precision, which may depend upon the requirements of the particular user. Also in a preferred embodiment, the user/customer is provided the option of specifying the interval between transmissions, the number of bursts at each transmission period, and so on. These parameters may be set before the beacon device 120 is launched, or, depending upon the capabilities of the particular beacon device, programmable after the device 120 is deployed, as customer requirements change. To conserve power, the interval between transmissions from the beacon device is preferably substantially greater than the duration of the transmission, preferably at least 10:1, and typically in the order of 100:1 or more, thereby providing a duty cycle in the order of 1% or less.

Optionally, the beacon device 120 may be configured to be triggered to send its location message based on parameters other than, or in addition to, time intervals, such as acceleration-based triggers, system-status triggers, external triggers, such as a prompt from the processing system 160, and so on.

The foregoing merely illustrates the principles of the invention. It will thus be appreciated that those skilled in the art will be able to devise various arrangements which, although not explicitly described or shown herein, embody the principles of the invention and are thus within its spirit and scope. For example, in addition to location information, the messages may also include additional information that facilitates the monitoring of the satellite, such as a monitor of In-, Cross-, and Radial-Track position and velocity information, as well as satellite power, and other status information. That is, the beacon device 120 may include accelerometers, attitude control sensors (e.g., sun, star, or earth sensors), and sensors to independently monitor the health of the satellite it is connected to (e.g., RF, optical, temperature sensors). In like manner, although the invention is presented in the context of a beacon device being placed on a satellite, the beacon device can be place on any space object, such as an approaching asteroid, large ‘space junk’ items, or other objects. These and other system configuration and optimization features will be evident to one of ordinary skill in the art in view of this disclosure, and are included within the scope of the following claims.

In interpreting these claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) each of the disclosed elements may be comprised of hardware portions (e.g., including discrete and integrated electronic circuitry), software portions (e.g., computer programming), and any combination thereof;

f) hardware portions may include a processor, and software portions may be stored on a computer-readable medium, and may be configured to cause the processor to perform some or all of the functions of one or more of the disclosed elements;

g) hardware portions may be comprised of one or both of analog and digital portions;

h) any of the disclosed devices or portions thereof may be combined together or separated into further portions unless specifically stated otherwise;

i) no specific sequence of acts is intended to be required unless specifically indicated; and

j) the term “plurality of” an element includes two or more of the claimed element, and does not imply any particular range of number of elements; that is, a plurality of elements can be as few as two elements, and can include an immeasurable number of elements.

We claim:

1. A satellite-tracking system comprising:
a plurality of beacon devices located on a corresponding plurality of space objects, each beacon device including a location sensor and configured to transmit location information,
a database that includes a plurality of sets of customer parameters, each customer being associated with a corresponding space object, each set of customer parameters including one or more intended recipient of messages associated with the corresponding space object,
a processing center that is configured to receive the location information from the plurality of beacon devices to determine the location of each corresponding space object, and
a message generator that is configured to selectively generate messages based on the set of customer parameters associated with each corresponding space object, and to send the generated messages to the corresponding intended recipients of the messages.

2. The system of claim 1, wherein the location messages include e-mail messages.

3. The system of claim 1, wherein each of the plurality of beacon devices are configured to transmit the location information independent of the transmissions of location information by each other beacon device.

4. The system of claim 1, wherein the plurality of beacon devices are configured to encode the location information using a common spreading code, and to autonomously transmit at a common carrier frequency.

5. The system of claim 4, wherein processing center includes a discriminator that is configured to distinguish the location information from each of the plurality or beacon devices based on a code-phase and a variation about the common carrier frequency.

6. The system of claim 1, wherein at least one of the sets of customer parameters includes one or more criterion for generating the messages.

7. The system of claim 6, wherein one or more of the criterion for generating the messages is dependent upon one or more of the intended recipients.

8. The system of claim 1, wherein the sets of customer parameters include an identification of a message format based on a type of receiving device associated with one or more of the intended recipients.

9. The system of claim 8, wherein the type of receiving device includes a cell phone.

10. The system of claim 8, wherein the type of receiving device includes a data portal.

11. The system of claim 1, wherein each of the beacon devices includes a GPS element that provides the location information.

12. The system of claim 1, wherein at least one of the beacon devices includes a Doppler correction element.

13. The system of claim 1, wherein one or more of the messages are formatted using one of: a TLE format and a VCM format.

14. The system of claim 1, wherein at least one of the beacon devices is configured to transmit one or more of: In-, Cross-, and Radial-Track position and velocity information.

15. The system of claim 1, wherein at least one of the beacon devices is configured to transmit status information related to the space object, in addition to the location information.

16. The system of claim 1, including one or more satellites that are configured to receive the location information from the plurality of beacon devices and to provide the location information to a ground station for communication to the processing center.

17. The system of claim 1, wherein each of the beacon devices is configured to transmit the location information periodically, at a time interval that is based on a customer requirement.

18. The system of claim 17, wherein the time interval is substantially larger than a duration of the transmission.

19. The system of claim 1, wherein one or more of the beacon devices is configured to transmit the location information based on a monitored status of the space object.

20. The system of claim 1, wherein one or more of the beacon devices is configured to transmit the location information based on receipt of an external prompt.

21. A method comprising:
receiving, at a receiving device, a composite signal that includes a plurality of location reports from a plurality of beacon devices situated on a corresponding plural of space objects,
decoding, at a decoder, each location report of the plurality of location reports,
determining, at a processing device, a location corresponding to each space object based on the location reports,
determining, by the processing device, a set of customer parameters associated with each space object, the customer parameters including identification of intended recipients for location messages,
generating, by the processing device, one or more location messages based on the location reports and the customer parameters, and
sending, by the processing device, the one or more location messages to the intended recipients.

22. The method of claim 21, wherein the location messages include e-mail messages.

23. The method of claim 21, wherein the plurality of beacon devices are configured to encode the location information using a common spreading code, and to autonomously transmit at a common carrier frequency, and the method includes distinguishing the location information from each of the plurality or beacon devices based on a code-phase and a variation about the common carrier frequency.

24. The method of claim 21, wherein at least one of the sets of customer parameters includes one or more criterion for generating the messages.

25. The method of claim 24, wherein one or more of the criterion for generating the messages is dependent upon one or more of the intended recipients.

26. The method of claim 21, wherein the sets of customer parameters include an identification of a message format based on a type of receiving device associated with one or more of the intended recipients.

27. The system of claim 26, wherein the type of receiving device includes a cell phone and a data portal.

28. The method of claim 21, wherein at least one of the beacon devices is configured to transmit status information related to the space object, in addition to the location information, and the method includes sending the status information to one or more of the intended recipients.

29. The method of claim 21, wherein one or more of the beacon devices is configured to transmit the location information at a periodic time interval that is based on a customer requirement, and the method includes setting the time interval at the one or more beacon devices.

30. The method of claim 21, wherein one or more of the messages are formatted using one of: a TLE format and a VCM format.

31. A tangible and non-transitory computer readable medium that includes code that, when executed by a processor, causes the processor to:
receive a composite signal that includes a plurality of location reports from a plurality of beacon devices situated on a corresponding plural of space objects,
decoding each location report of the plurality of location reports,
determining a location corresponding to each space object based on the location reports,
determining a set of customer parameters associated with each space object, the customer parameters including identification of intended recipients for location messages,
generating one or more location messages based on the location reports and the customer parameters, and
sending the one or more location messages to the intended recipients.

32. The medium of claim 31, wherein the location messages include e-mail messages.

33. The medium of claim 31, wherein the plurality of beacon devices are configured to encode the location information using a common spreading code, and to autonomously transmit at a common carrier frequency, and the code is configured to cause the processor to distinguish the location information from each of the plurality or beacon devices based on a code-phase and a variation about the common carrier frequency.

34. The medium of claim 31, wherein at least one of the sets of customer parameters includes one or more criterion for generating the messages.

35. The medium of claim 34, wherein one or more of the criterion for generating the messages is dependent upon one or more of the intended recipients.

36. The medium of claim 31, wherein the sets of customer parameters include an identification of a message format based on a type of receiving device associated with one or more of the intended recipients.

37. The system of claim 26, wherein the type of receiving device includes a cell phone and a data portal.

38. The medium of claim 31, wherein at least one of the beacon devices is configured to transmit status information related to the space object, in addition to the location information, and the code is configured to cause the processor to send the status information to one or more of the intended recipients.

39. The medium of claim 31, wherein one or more of the beacon devices is configured to transmit the location information at a periodic time interval that is based on a customer requirement, and the code is configured to cause the processor to set the time interval at the one or more beacon devices.

40. The medium of claim 31, wherein one or more of the messages are formatted using one of: a TLE format and a VCM format.
